(19) United States
(12) Patent Application Publication
(10) Pub. No.: US 2005/0246266 A1
(43) Pub. Date: Nov. 3, 2005

(54) System and apparatus for hosting combined online and live auctions

(76) Inventors: Zeljko Stefanovic, Moose Jaw (CA); Roe Peterson, Regina (CA); Bob Francis, Moose Jaw (CA)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/177,154

(22) Filed: Jul. 7, 2005

Related U.S. Application Data
(63) Continuation of application No. 09/695,539, filed on Oct. 24, 2000.

(51) Int. Cl. G06F 17/60

(52) U.S. Cl. 705/37

(57) ABSTRACT

A system for the hosting of a combined auction, with live bidders in physical presence at the auction site as well as online bidders being able to view the auction and bid over the Internet. Auction and bid processing are centralized on a central control system. A remote module is used at the actual physical site of the auction and provides site data to the central control system for handling and distribution to bidders. The technical requirements at the actual auction site are minimized by the centralization of the majority of auction processing, and high-speed network connectivity requirements between the auction site and the central processing system are minimized.

This invention is in the field of auction systems, and more particularly deals with a system and method for the conduct of an auction at an auction site with bidders both in physical attendance at the auction site as well as being present at the auction via an Internet broadcast.

### BACKGROUND

In the c-commerce arena, there is a proliferation of online auction sites. Most of these sites simply allow a bidder to post a bid to an auction hosted on a Web site, which auction might either be static in nature and run over an extended period of time, or in certain circumstances may run on a shorter timeline and somewhat more closely approximate the experience of a traditional auction with an auctioneer. Traditional auctions with an auctioneer also remain popular for both buyers and sellers insofar as equipment or products auctioned often times receive increased prices the auction method as traditionally practiced is simple to use for everyone and is adaptable to any industry.

One of the primary concerns of an auctioneer in preparing an auction sale is to ensure as large a number of bidders in attendance at the sale as possible, which will maximize the potential of bids and increased returns on different lots in the sale. Particularly in cases where the items being auctioned are large or unwieldy to transport, such as agricultural or industrial equipment, it is necessary for people interested in viewing and bidding on that equipment to actually travel to the site of the auction since the costs of transport of the equipment, generally speaking, means that it is impractical to consolidate the equipment elsewhere off of the previous location of that equipment. People who are only interested or looking at one or two lots in a larger sale may not be able to justify the cost of travel if the travel is a long distance or to a remote location, to participate in such an auction sale.

One alterative to travelling to such an auction sale is to conduct the sale entirely online over the Internet or another computer network or communications network, but in the case of a traditional online auction the quality of the interaction between the auctioneer and bidders in attendance at the sale in the electronic format is diminished. Furthermore, it is difficult to generate the same level of excitement in a static online auction sale that is found in a fast-paced physical auction sale, in which higher bids might be secured on various auction lots.

It would be preferable to provide a system and method for the conduct of an auction which would allow for the attendance and participation of bidders at the physical auction site as well as other bidders who could not physically attend being able to participate in an online format.

### SUMMARY OF THE INVENTION

It is the object of the present invention to overcome the limitations of the prior art.

It is more specifically the object of the present invention to provide a system and method for the conduct of an auction at an auction site which would allow for placement of auction bids by bidders in physical attendance at the auction site, as well as by bidders in virtual presence at the auction by way of a connection over the Internet.

It is the further object of the present invention to provide a system allowing for the conduct of auctions with both live and online bidders where it is not necessary to transport and install a significant quantity of computer equipment at the auction site. It is the further object of the present invention to provide such a system which requires minimal network connectivity from the auction site.

The present invention accomplishes these objectives in a first embodiment being an apparatus for the conduct of an auction from a physical location allowing for the participation of both live bidders and online bidders, wherein a live bidder is a bidder present at the auction site and an online bidder is a bidder who is not present at the auction site, but who has computer access to the auction sale, wherein the apparatus itself comprises an auction Web site system which is able to communicate with the bidder computers of online bidders and receive online bids, said Web site system including software components for the handling of bids, and a site terminal being located at the physical location of the auction which is operatively connected to said Web site system, which site terminal transmits the details of live bids placed by live bidders in attendance at the physical location to the Web site system. Online bids and live bids are all transmitted to the Web site system by either bidder computers or the site terminal and are recorded by the auction software components in the Web Site system. This allows for both live bidders and online bidders to bid on the same auction lot at the same time.

The auction software components of the Web site system of the present invention would record bids in the Web site system in the order they were received, which might be accomplished by the assignment of either time stamp or sequence code to the bids upon their receipt by said Web site system.

An auctioneer could be present at the live physical location of the auction and participate in the auction, or alternatively would not be necessary. It will be understood that both the participation of an auctioneer or the running of an auction without an auctioneer are contemplated within the scope of the present invention. Insofar as the live bidder at the auction site would likely not wish to be there for a long period of time, it will be understood that the primary application of the apparatus of the invention is what will be termed a “live” auction, with a bidding session of a limited duration of time, versus a “static” auction, such as those conducted on eBay™ or the like where the bidding session might be stretched to a number of days. It will, however, be understood that the apparatus of the present invention could also be used with such a static auction and, as such, the applicability thereof is also contemplated within the scope of the present invention.

Where an auctioneer was participating in the auction or where it was otherwise desirable to have online bidders be able to actually view content from the auction site, such as pictures or live content of the auction lot itself or the like, at least one media capture device could be added at the site and could be operatively connected to the site terminal. The media capture device might be something such as a microphone to capture the feel from an auctioneer's participation, or alternatively or cumulatively also include a camera or the like to show pictures of an auction lot or the auction site itself. The media input itself from these media capture devices which are connected to the site terminal would be transmitted by the site terminal to the Web site system, and from the Web site system the media input would then be streamed or broadcast Out to the bidder computers for viewing therein. While it is obviously the object of the present invention to keep processing requirements at the actual auction location to a minimum, the site terminal might partially process the media input from the media capture devices in advance of transmitting same to the Web site system. For example, compression might be applied or other techniques used.

The apparatus of the present invention could be further modified wherein the Web site system would provide up-to-date auction status information to bidders as bids were recorded or accepted. Auction status information might be provided to an online bidder by transmitting that information to their bidder computer. In the case of a live bidder present at the auction site, the auction status information might be displayed to live bidders by transmitting that information to site terminal for display, announcement or other use.

In certain cases, the Web site system of the present invention and the site terminal would be one computer, or in others the Web site system and the site terminal could be separate computers. The Web site system might either be located at the same location as the auction location or, alternatively, could be located in a centralized computing location away from the auction site.

The auction software components of the Web site system of the present invention might optimally comprise a merchandise database containing information pertaining to auction lots, and a bid database containing details of bids received from both online and live bidders with respect to auction lots. An auction control system which would control the actual process and acceptance of bids would, during the conduct of an auction, receive live bid details from the site terminal and online bids from bidder computers, and record the details of both said live bids and online bids in the bid database. Upon detection of an auction-closing condition, the auction control system would accept no further bids and the successful bidder could then either be determined manually by an operator of said Web site system or alternatively could be determined by the auction control system in the comparison of successfully recorded bids from the bid database.

Also disclosed is a method of conducting an auction which allows the placement of online bids from an online bidder as well as the placement of live bids by live bidders present at an auction location, said method comprising the steps of providing an auction Web site system which can communicate with the bidder computers of online bidders, said Web site system including auction software components capable of receiving and recording online bids and live bids in respect of auction lots, and providing a site terminal at the auction location which is operatively connected to the Web site system, the Web site system and site terminal used to conduct an auction thereof by accepting online bids transmitted from bidder computers to the Web site system, allowing live bidders to place live bids at the auction location with the details of the live bids then being entered into said site terminal for transmission to the Web site system for recordal therein as live bids, recording bids received from online and live bidders in the Web site system as received, and upon detection of an auction-closing condition, ceasing the acceptance of any further bids by said Web site system.

This method might further comprise the step of displaying up-to-date status information pertaining to an auction lot to online bidders at their bidder computers or to live bidders via the site terminal.

Media content such as audio/video could be captured at the auction site and transmitted via the site terminal to the Web site system from whence it could be broadcast to bidder computers engaged in the bidding session.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a general architectural drawing of one embodiment of the system of the present invention;

FIG. 2 shows the component of the system of FIG. 1 in more detail;

FIG. 3 demonstrates the flow of a typical series of auction transactions through the system of FIGS. 1 and 2;

FIGS. 4 to XX are sample Web pages which might be used in the conduct of an auction in accordance with the present invention.

### DETAILED DESCRIPTION OF THE ILLUSTRATED EMBODIMENTS

To facilitate a complete understanding of the invention, the description of the preferred embodiments herein are arranged within the following sections:
1. Glossary of Terms and Acronyms
2. Overview of System Components and Operation
3. Auction Software Components
4. Media Capture
5. Communication Between Site Terminal and Auction Server
6. Conclusion
   Glossary of Terms and Acronyms

The following terms and acronyms are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”). Used herein to refer generally to both a distributed collection of interlinked, user-viewable hypertext documents (commonly referred to as Web documents or Web pages) that are accessible via the Internet, and the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web site. A computer system that serves informational content over a network using the standard protocols of the World Wide Web. Typically, a Web site corresponds to a particular Internet domain name, such as abc.com,” and includes the content associated with a particular organization. As used herein, the term is generally intended to encompass both the hardware/software server components that serve the informational content over the network, and the “back end” hardware/software components, including any non-standard or specialized components, that interact with the server components to perform services for Web site users.

HTTP (Hypertext Transport Protocol). The standard World Wide Web client-server protocol used for the exchange of information (such as HTML documents, and client requests for such documents) between a browser and a Web server. HTTP includes a number of different types of messages which can be sent from the client to the server to request different types of server actions.

“HTML” (Hypertext Mark-up Language). A standard coding convention and set of codes for attaching presentation and linking attributes to informational content within documents. During a document authoring stage, the HTML codes are embedded within the informational content of the document and when the Web document (HTML document) is subsequently transferred from a Web server to a browser, the codes are interpreted by the browser and used to parse and display the document. In addition to specifying how the Web browser is to display a document, HTML tags can also be used to create links to other Web documents.

Overview of System Components and Operation

An inventive system and method is disclosed for conducting a multi-bidder interactive auction allowing both the participation of bidders online by computer connection, as well as allowing bidders to actually attend at an auction site to view the merchandise lots and/or to place live bids. Implemented in the combination of software and hardware components outlined in more detail below, the electronic auction system allows a group of live and online bidders to interactively place bids which are communicated over a computer communications network to an auction Web site system which automatically records the bids and updates all of the bidders with the current auction status information, closes the auction from further bidding when appropriate and determines the successful bidder.

Bidders who wish to access the auction and place bids from a remote location away from the site of the auction, and who will access the system by way of a computer connection, are referred to as “online bidders” in the course of the remainder of this description. A bid placed by an online bidder over the computer is an “online bid”. With respect to people who actually wish to attend at the physical site of the auction, these are referred to as “live bidders” throughout the remainder of the description hereof, and a bid placed by a live bidder is a “live bid”. A live bid might be placed by a live bidder at the auction location either in the traditional fashion of announcing or indicating the bid to an auctioneer, or alternatively the site terminal itself might be equipped to allow live bidders wishing to attend at the auction site to place a bid in a similar fashion to that of an online bidder whereby a live bid would actually he a bid submitted from the site terminal directly by a live bidder. Alternatively, where bids were placed in a traditional fashion, such as indicating the placement or acceptance of a bid to an auctioneer present at the location of the auction, the auctioneer or an assistant might enter the details of the live bids into the site terminal and transmit them to the Web site system in that fashion.

The system and method of the present invention lends itself particularly to the execution of a short term or real time auction, emulating a traditional auction in which bidders are present in the auction hall and an auctioneer induces bids from bidders in the auction hall on a particular auction lot up for sale. While it is not particularly contemplated that the method of the present invention would be preferably practiced in a static online auction format, such as that on eBay™ or the like, it will be understood that a static auction format would also fall within the scope of the claimed invention as well.

The system and method of the present invention employs a client server methodology, both in terms of the communication of online bidders via their bidder computers with the Web site system of the present invention as well as with the site terminal which is used to record and transmit the details of the live bids placed by live bidders to the Web site system for recordal. Obviously, the client server design of the Web site system of the present invention allows bidders who can access said Web site system via a bidder computer and browser and/or Internet connection, but it also decreases the amount of electronic equipment and gear which must be transported to and installed at the actual auction site if it is desired to actually run the auction from the auction site rather than from a remote server location. It would particularly be the case that it would be desired to operate at least the visible aspect of the auction process from the auction site where it was desired to still run a quasi-traditional auction with an auctioneer taking part in the auction to induce more bids.

The reduction of the equipment requirements and communications overhead required at an auction site will expand the reach of the system and method of the present invention. For example, there might be a situation where it was desired to auction a large number of pieces of unwieldy equipment which it would be prohibitively expensive to move in advance of auction to a traditional auction yard. The system of the present invention allows for the set up of only a site terminal at the actual physical location of the auction and an auctioneer could then participate, or not as the case may be, in the auction from the auction site where live bidders in physical attendance at the auction site could view the lots for sale and place live bids therefrom, while online bidders could place online bids with the Web site system of the present invention by transmission of their bids directly to the Web site system rather than to the site terminal. The “back office” functions of the auction can still take place at a central computing center where the Web site system of the present invention is installed, but the outreach which is provided to auctioneers employing this type of a system is exponential insofar as in certain cases all that would be necessary at an auction site would be a simple telephone line or the like to establish an Internet connection between the site terminal and the Web site system for communication of auction status information to the site terminal regarding online bids received at the computing center, as well as for the purpose of communicating live bids back to the central system.

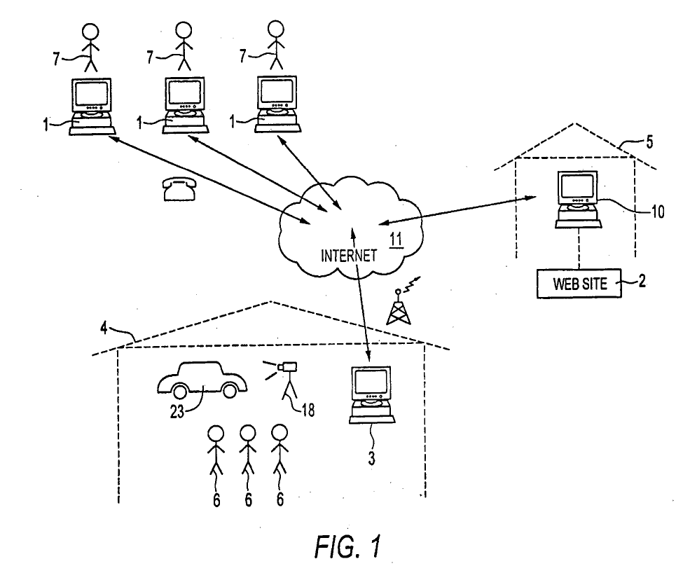

FIG. 1 illustrates the general architecture of an auction system in accordance with the present invention. It includes at least one bidder computer (1), an auction Web site system (2), and a site terminal (3). The site terminal (3) is located at the actual auction site (4), whereas the auction Web site system (2) could be physically domiciled at a remote computing site (5). It will be understood that the location of the Web site system (2) and the site terminal (3) at the same location or in different locations is contemplated within the scope of the present invention. The site terminal (3) is operatively connected in communication with said Web site system (2). Similarly, the bidder computers (1) can also communicate with the auction Web site system (2). In this particular case, three bidder computers (1) are shown, but it will be understood that any number of bidder computers (1) which could be accommodated by the hardware capacity of the auction Web site system (2) are contemplated within the scope of the present invention. In association with the bidder computers (1) which are illustrated therein, the bidder computers (1) insofar as they communicate with the Web site (2) by the Internet (11) could be connected by modem or any other available method of Internet connection and it will be understood that the present invention is intended to encompass all such methods of physical connection of the bidder computer; (1) to the Web site (2).

Furthermore, for the sake of illustration of the second half of the bidding equation of this invention, three live bidders (6) are shown who are in physical attendance at the auction site (4). Again, it will be understood that in terms of the numbers of live bidders (6) who could be accommodated at the auction site (4), that will be limited only by the communication capacity of the site terminal (3) to the auction Web site system (2), as well as the practical capacity of the auction venue and/or the auctioneer involved in the sale. It will be understood that in a situation where a large number of live bidders (6) were anticipated at the auction venue (4), additional site terminals (3) could be added to provide for additional communication capacity with the central auction Web site system (2) whether it be on or off site.

The bidder computers (1) are connected to the auction Web site system (2) via the Internet (11). It will be understood that the bidder computers (1) might be any type of a computing device that would allow an online bidder to interactively browse Web sites via a Web browser (12). For example, the bidder computer (1) might be a personal computer running any one of the Microsoft Windows™ operating systems. It will be understood that any types of computing devices running other operating systems could also be used as the bidder computer (1) so long as they were able to connect to the Internet (11) to establish communications with he auction Web site system (2) and transmit online bids thereto. It will be understood that all such other capable devices are contemplated within the scope of the present invention.

The site terminal (3) is a adapted to communicate with the Web site system (2) as well. The site terminal (3) might communicate with the auction Web site system (2) also over the Internet (11), or by some type of a private or proprietary network connection. As shown here, the site terminal (3) and the Web site system (2) are physically separated at two different locations. It will also be understood that the site terminal (3) and the Web site system (2) might be domiciled in the same physical location, in the situation where the entire system of the present invention was installed in a permanent auction venue or the like, and it will also be understood that in such a case where the site terminal (3) and the site of the auction (4) are in the same place as the Web site system (2), the Web site system (2) and the site terminal (3) might actually be combined into the same set of computing hardware. While separate hardware is demonstrated in these figures, it will be understood that this combination of the hardware into a single unit is also contemplated within the scope of the present invention.

The link between the Web site system (2) and the bidder computer (1) does not have to be a physical link—it can, for example, be a link via a modem, some type of a radio connection or any other link. An online bid could be submitted from any one of the bidder computers (1).

The Web site system depicted in FIG. 1 may be embodied in hardware specifically provided to implement the present invention or alternatively the system may be implemented using the infrastructure that already exists in a particular company or for a particular user. It is particularly contemplated that the server (10) of the Web site system (2), and the bidder computer (1) and site terminal (3), might be a server computer and client computers operatively connected by the Internet. The hardware and communications links of these systems might be used as an infrastructure for the practice of the present invention. Changes to the existing central server computers (10) to incorporate the subject invention may be accomplished in various ways, such as programming an existing central file server computer or by adding an additional central file server computer (with or without a CPU entirely dedicated to the processing of bid information). Alternatively, the subject invention may be implemented using existing hardware entirely, making appropriate software updates.

It is necessary to yet again stress the versatility of the present system which is provided by centralizing the majority of the accounting and information functions of the conduct of a combined online and live auction in the Web site system (2) of the present invention, with the site terminal (3) and/or the bidder computers (1) potentially simply operatively connected to the Web site system (2) via the Internet. In particular, the server (10) of the Web site system (2) might communicate with the site terminal (3) by way of a modem, network connection or some other method or apparatus allowing for the transmission or receipt of data between the central server (10) and an external device. While the illustrated embodiment here uses a wireless network connection over the Internet to communicate between the site terminal (3) and the server (10)/Web site system (2), it should be understood that other method of communication could be used instead. These other methods include hardwired connections, radio communications, optical communications and the like, and it will be understood that all such method of communication between the site terminal (3) and the Web site system (2) and its server (10), regardless of communication protocol, are contemplated within the scope of the present invention.

As outlined above, in this particular case, the communications link between the site terminal (3) and the Web site system (2) and its server (10) is by way of a wireless Internet connection. The use of such a connection allows for the conduct of an auction of the present invention at virtually any location to which such a wireless or radio communications link can be established, since depending upon the period of time involved in the conduct of the auction the actual site terminal (3) might even be a battery powered portable computer. An auctioneer who used the system of the present invention could feasibly conduct an auction with online and live bidders in any location to which the necessary communications link could be established and to which the requisite power requirements could be satisfied for the minimal amount of hardware on site, ie. the site terminal (3). In the case of a local auction company, for example, agricultural auctions could be held in various farm locations so long as a wireless connection could be established back to the central office of the auction company where the Web site system (2) and its server (10) were domiciled. To stretch this further, an auctioneer could feasibly run a physical and/or online auction at an auction site anywhere in the world so long as there was the ability to connect to the Internet and establish a link back to the Web site system (2).

The centralization of computing functions in this auction format also results in a decreased amount of communications bandwidth required between the site terminal (3) and the Web site system (2). This allows for the use of the system of the present invention even in areas where only a slower speed communications link could be established.

There is also shown in FIG. 1 an auction lot (23) itself at the auction location (4) which in this case and in this illustration is a car.

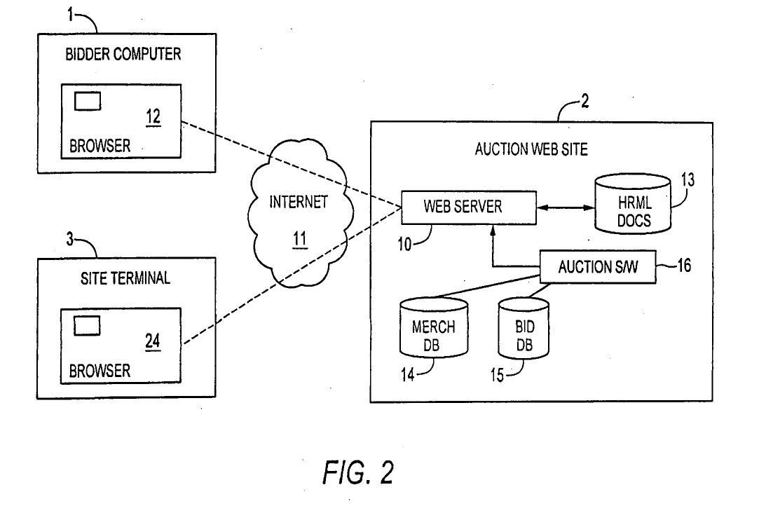

FIG. 2 demonstrates the details of the computers of the present system and embodiment in more detail. The Web site system (2) includes, in terms of hardware, a server (10). The server (10) will be capable of executing various program instructions and operating various software components required in the operation of the system and method of the present invention. The auction Web site system (2) will interface with a bidder computer(s) (1) by way of a bidder Web browser (12). Software components (16) within the server (10) are capable of serving content to the Web browser (12) from a repository of HTML documents (13) or the like contained within the storage area of the server (10). For example, an online bidder from their Web browser (12) could send a request to the Web site system (2) to view information with respect to a particular auction lot and/or to place a bid thereon, and the server (10) could interpret that request and by way of its software components (16) retrieve information from it,s HTML document repository (13) and serve same information back to the Web browser (12) on the bidder computer (1). The basic client server operation of a Web server (10) and Web browser (12) will be understood to one skilled in the art, and all such basic variations thereon are contemplated within the scope of the present invention.

Contained within the memory of the server (10), accessible to computer software components (16) executed thereon, is a merchandise database (14) which contains information pertaining to various auction lots (23) to be auctioned off for sale. Various types of information might be stored with respect to different auction lots (23), including descriptive information for the use of bidders as well as other information such as pricing or bidding parameters to be used internally by the system (2).

The auction Web site system (2) would also include a bid database (15) in which would be stored the particulars of bids received from various bidders in respect of auctions of auction lots (23) from the database (14). As in the case of the merchandise database (14), it will be understood that the bid database (15) could also contain additional information to extend the functionality of the system of the present invention, but the baseline requirements for the proper operation of the system would be to store the bid amount, an indication of the auction lot in respect of which the bid is placed, as well as identification of the bidder placing the bid.

Where the site terminal (3) was also connected via the Internet (11) to the Web site system (2) and its associated server (10), the site terminal (3) might also employ a Web browser (24) to interact with the server (0). Again, documents from the document repository (13) of the server (10) could be served to the terminal browser (24) upon request thereby and those documents from the repository (13) might include various data entry forms by way of which an operator of the site terminal (3) could provide information or bid details back to the Web site system (2). The terminal browser (24) transmits the details of live bids from the auction site (4) to the Web site system (2).

In operation, an online bidder (7) could access the auction Web site system (2) using a standard Web browser (12), using a protocol such as HTTP to communicate with the Web server (10) of the Web site system (2). Through the auction Web site system (2) and the associated Web server (10), the online bidder (7) is able to transact business and place bids with the system (2). The customer might also choose to or be able to view descriptive information from the merchandise database (14) about various merchandise lots (23), and at the heart of the invention can participate in auctions of various merchandise lots (23) of which information is stored in the merchandise database (14) by being able to place online bids (9) in respect thereof. An online bidder (7) can, through their Web browser (12) and their bidder computer (1), place online bids (9) on a lot or lots (23) up for auction and potentially purchase such auction lots (23) if they are the successful bidder in such an auction.

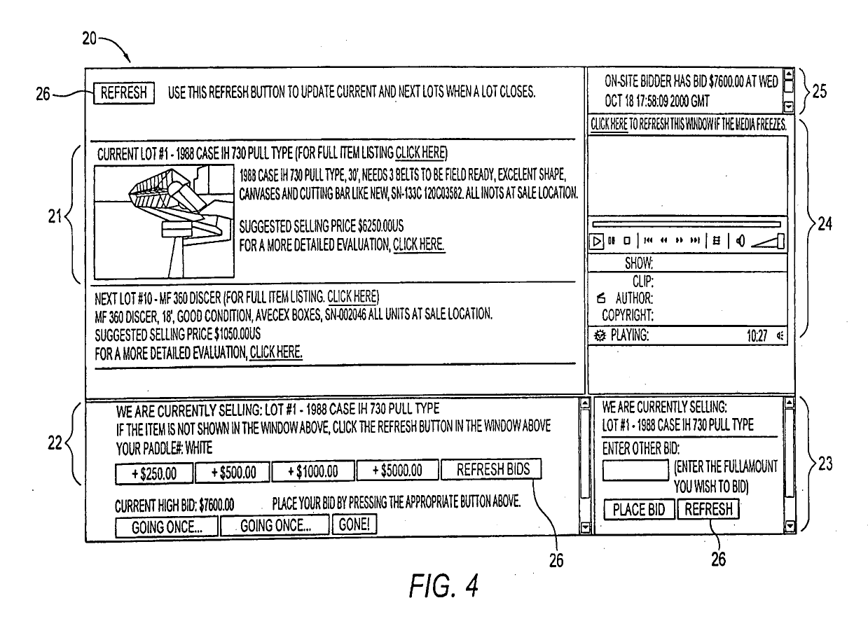

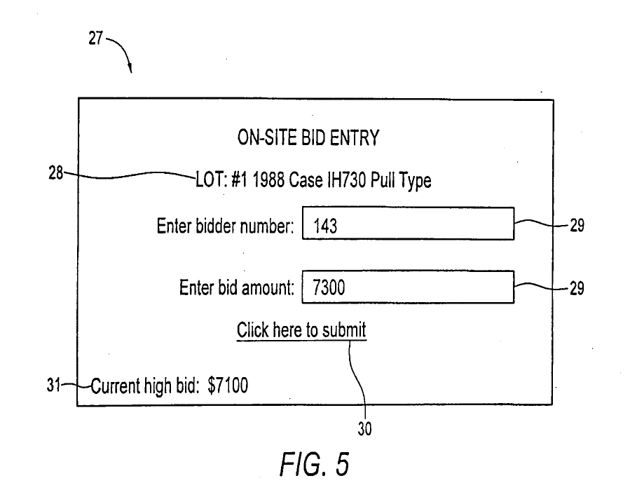

During an auction bidding session in respect of a merchandise lot (23), they might view up-to-date status information of the auction in their browser (12) by requesting that information from the server (10) which would serve it from its HTML document repository (13). When the online bidder sees an opportunity at which they would like to place a bid they could, through a form on the HTML document that they were viewing, enter the particulars of their bid and transmit that to the Web site system (2) for recordal in the bid database (15). FIG. 4 demonstrates one type of a screen display which might take place in the course of an auction wherein an online bidder was placing a bid on an auction lot. The sample HTML page (20) which would be viewed in a bidder browser shows in this case details pertaining to the particular auction lot in question from the merchandise database (14). These details are shown at (21). The system shown in the sample document (20) includes both a series of predetermined bid increments in one frame at the bottom of the screen (22), from which an online bidder could select a bid amount, or alternatively there is shown in another frame (23) an area in which a bid could be entered and transmitted to the server (10) by clicking on the place bid button or hyperlink shown on that screen which would result in the communication of the contents of the form fields on the page (20) back to the server (10) for further processing by the auction software (16). It will be understood that many different varieties of interfaces between the browser (12) and the server (10), and many different HTML templates or the like could be contemplated, and in fact the options are almost limitless, and that all such presentations of similar information are contemplated within the scope of the present invention. Also shown in FIG. 4, at (24), is another frame in which live video from the auction site (4) can be played, if captured by a camera (18) on site. This will be discussed in more detail below.

A screen such as the one shown in FIG. 4 also shows, in its top corner at (25), the status of the auction insofar as all of the bids being placed. It can be seen that an on-site bidder (aka. a live bidder) has placed the last bid at the amount of $7,300. The server (10) could be programmed to automatically refresh the HTML page (20) in predetermined time increments, or alternatively it can be seen that there are several hyperlinks displayed on the page, shown at (26), which would initiate manual refreshing of a document.

Having outlined the method of participation by an online bidder (7) in an auction in accordance with the present invention, it is also necessary to review the method of participation of the live bidders (6) who are in physical attendance at the auction site (4). A live bidder (6) could place a conventional live bid (8) with respect to an ongoing auction by announcing or confirming the details of such a live bid (8) to an operator of the auction at the auction site (4). The details of live bids (8) received from live bidders (6) present at the auction site (4) would be communicated to the auction Web site system (2) via their data entry at the site terminal (3). As outlined above, the communication between the site terminal (3) and the auction Web site system (2)/server (10) might also consist of data entry forms from the HTML document repository (13) on the server (10) which would allow for the submission of information, namely details of live bids (8) to the auction Web site system (2) and the server (10), where such data would be stored into the bid database (15) along with the details of online bids (9) which had also been received in respect of the same auction lot (23).

It is specifically contemplated that a live auctioneer might also be engaged in the auction of an auction lot (23) and would in their personal presence be able to induce the placement of live bids (8) by live bidders (6) present at the auction site (4). The broadcast or webcast of the audio or video of the auctioneer from the auction site (4) to the online bidders (7), by capturing such multimedia content and transmitting same from the site terminal (3) to the server (10) where it in turn can be broadcast to the bidder computers (1), is outlined in more detail below.

FIG. 5 shows one example of an HTML form which might be used in the browser (24) of a site terminal (3) to allow an operator to enter details of live bids received at the site (4). Again, in a situation where the site terminal (3) communicated with the Web site system (2) by way of a browser (24), an HTML form or screen similar to that in FIG. 4 used for online bids might be used. In this particular case of FIG. 5, there is shown as sample screen or type of information which might be submitted from the site terminal (3) to the Web site system (2) in logging live bids. The screen (27) again shows identifying data from the merchandise database regarding the lot currently being auctioned, shown at (28). It will be understood that the lot number or lot identification information might be automatically refreshed to the screen of the site terminal (3) as the auction progresses, or alternatively the data entry of live bids at the site terminal (3)/browser (24) might include also supplying the bid and lot number or identification to which the bid entered is to be applied. Also shown are data entry fields (29) in which the details of the on-site bid can be entered and then a link (30) is shown, the activation of which transmits the content of this type of a form back to the Web site (2). Again, as in the case of the online bid screen of FIG. 4, it will be understood that virtually infinite variations on an on-site bid entry screen are interfaced with the Web site (2) way of a browser (24) could be contemplated and that all are contemplated within the scope of the present invention. Also shown in the form (27) is a field (31) which displays the current high bid. This could be listed by the auctioneer or live bidders in attendance at the auction site in assessing or placing bids.

Upon recordal of bids (8) and (9) in the bid database (15), the server (10) would provide revised or up-to-date auction status information and pricing to all online bidders (7) or live bidders (6) engaged in the auction. The up-to-date status information would be communicated to online bidders (7) by refreshing or updating the display (20) within the online bidders' Web browsers (12). With respect to live bidders (6), the up-to-date pricing or status information could be communicated back to the site terminal (3) or the browser (24) therein for display or announcement to live bidders (6) in attendance at the auction site (4).

The system of the present invention could be programmed to monitor the conditions of the sale to detect an auction-closing condition. The auction-closing conditions, which would be the trigger to close the auction of a particular lot (23), might be either a manual trigger by an operator at either the site terminal (3) or the Web site server (10), or alternatively the auction-closing condition might be a calculation or condition based on other circumstances of the sale, such as or including, but not limited to, the passage of a certain amount of time between placement of bids, or the like. It will be understood that any particular type of auction-closing condition which could be detected by the server (10) is contemplated within the scope of the present invention. Upon detection of an auction-closing condition, the server (10) would accept no further bids (8) and (9) and the successful bidder could be determined with respect to the lot (23) being auctioned, based on the relevant bids which had been stored in the bid database (15). The winning bid could be selected manually by an operator of the Web site system (2) or the site terminal (3), or alternatively could be automatically be selected by the Web site (2) and communicated to bidders at the site terminal (3) and bidder computers (1).

The following sections outline in more detail some of the various embodiments or functions which might be used in conjunction with the present invention.

Auction Software Components

The server (10) of the Web site system (2) has a series of software components therein for the operation of an auction sale. Many software components are already available for the management or auction sales or the management of bidding during an auction sale. The modification of these software components and the supporting hardware to accept bids from both live and online bidders (6) and (7) is at the heart of the invention.

The software components in a typical auction system might include a merchandise management component (19) which is operatively connected to an manages a merchandise database (14) which contains information pertaining to auction lots (23), as well as a bid management system (20) which will access a bid database (15) and store details of bids received by the system therein. There might also be included an auction control component (21) which is actually responsible for receiving bids transmitted from bidders and forwarding them to the bid management system (20) for recordal in the bid database (15), as well as which might provide the up-to-date status information back to bidders involved in the auction and/or monitor the auction for the occurrence of an auction-closing event. Insofar as many various types of software components could be used, it will be understood that all such variations are contemplated within the scope hereof.

As outlined in the general summary section above, the merchandise database (14) might contain both publicly and externally accessible information regarding various merchandise lots (23) for sale, which information could be viewed or accessed by online bidders (7) from their computers (1), or by a live bidder (6) either by way of a browser (24) on the site terminal (3) or the information could be physically communicated to live bidders (6) at the auction site (4) by an operator of the site terminal (3). The database (14) might also include internal information used in the pricing or conduct of an auction of the particular merchandise lot (23) to which it pertains. It will be understood that the type of information which can be stored in the merchandise database (14) is limited solely by the data structure thereof and that all such data structures are contemplated within the scope of the present invention.

The level of detail of information stored in the merchandise database (14) might vary. In a bare situation, the merchandise database (14) may contain only skeletal information for the use of the system (2) in the conduct of auction sales. Alternatively, where information from the merchandise database (14) is going to be made available to either online or live bidders, (7) and (6) respectively, for review in the course of an auction the database (14) might contain more detailed publicly available information such as specifications or details of lots (23) stored therein.

The Web server (10) of the auction Web site system (2) of the present invention would include software components (16) which would carry out the administration and operation of the system. The first element of the software components (16) would be a merchandise management component (19) which would be responsible for the upkeep of the records of merchandise lots (23) stored in the merchandise database (14). As summarily outlined above, the system (2) includes a merchandise database (14), each record of which would correspond to a merchandise lot (23) which was to be auctioned using the Web site system (2) of the present invention. The merchandise database (14) is stored in the memory of the server (10) and the merchandise management component (19) could be any software component capable of accessing and managing or administering the merchandise database (14).

It will be understood that the database structure of the merchandise database (14) could be any type of a database or file structure which could be administered by a software component (19) within the Web server (10), and that all types of data structures are contemplated within the scope of the present invention.

The merchandise management component (19) would have several functions. The first function of the merchandise management component (19) would be to maintain any changes made to records in the merchandise database (14) as a result of or during auctions conducted by the remainder of the system (2). As well, the merchandise maintenance component (19) could be responsible for serving information from the merchandise database (14) either to other software components within the system (2) or to a browser (12) of a bidder in a bidder computer (1). While beyond the immediate scope of the present invention, it will be understood that the merchandise management component software (19) could also allow for administration and adding or deleting lots to or from the database (14), or archiving information therefrom upon completion of various auction sales.

The merchandise management component (19) would interface with the bid management component (20), outlined in more detail below, as well as the auction control component (21) of the system (2), which is also discussed in more detail below, insofar as the auction control component (21) needs to access up-to-date lot information from the merchandise database (14), and bids likely need to be referenced to a record in the merchandise database (14) when written to the bid database (15).

The next software component of the computer software (16) within the server (10) would be the bid management component (20). The bid management component (20) would be present in the software (16) in the server (10) and would be responsible for the management or administration of a bid database (15).

The bid database (15) would be used to record various bids received from either online bidders (7) or live bidders (6) at the Web site system (2) with respect to auctions of various auction lots (23). The bids which are recorded in the bid database (15) could then be reviewed by a software component upon completion of an auction to determine the winning bid. Storage of the bidding files for later historical analysis of the bidding patterns in a particular auction, or even for security purpose to review who made which bids when, is also contemplated herein.

It will be understood that the type of information which would be recorded in the bid database (15) with respect to bids placed by bidders in an auction sale could again vary in levels of complexity. Likely, the basic information which would need to be stored would be the bid price, as well as an identifier or identification of the bidder placing the bid which might be linked to a bidder database, as well as an identifier of the particular auction lot (23) within the merchandise database (14) upon which the bid was placed. Other data checking fields in the data structure of the bid database (15) might include date and time of bids, validation or processing flags or the like. It will be understood that the bid maintenance component (20) is responsible for the maintenance of the bid database (15).

As in the case of other databases contemplated within the scope of the present invention, the bid database (15) would, in a preferred embodiment, be a database structure containing a plurality of records, each record corresponding to a bid placed by a bidder with respect to a merchandise lot (23). It will be understood that the structure of the database (15) could actually be any type of a database or other file structure which is accessible to the system and software components within the server (10). Summarily, the bid database management component (20) could be any software component capable of accessing and administering the particular database structure chosen for the bid database (15).

In addition to the requirement to maintain information pertaining to auction lots (23) to be auctioned for sale, as well as to maintain complete information pertaining to bids received from bidders on auction lots (23) when offered for sale, the next auction software component which needs to be examined briefly is the auction control component itself. It would be necessary to have an auction control component (21) installed within or operatively connected to the server (10) as well, which auction control component (21) would be capable of coordinating the conduct of an information recordal during an actual auction of an auction lot (23).

The auction control component (21) could be any software component installed on or operatively engaged with the server (10) which is capable of receiving details of bids transmitted either from the bidder computers (1) of online bidders (7), or alternatively from a site terminal (3) with respect to live bids placed by live bidders (6) at the auction venue (4), and shuttling those derails to be recorded in the bid database (15) in the proper order and fashion.

The auction control component (21) would also be responsible for the communication of up-to-date auction pricing and status information to all bidders, as required.

It will be understood that any software component capable of performing these duties is contemplated within the scope of the present invention.

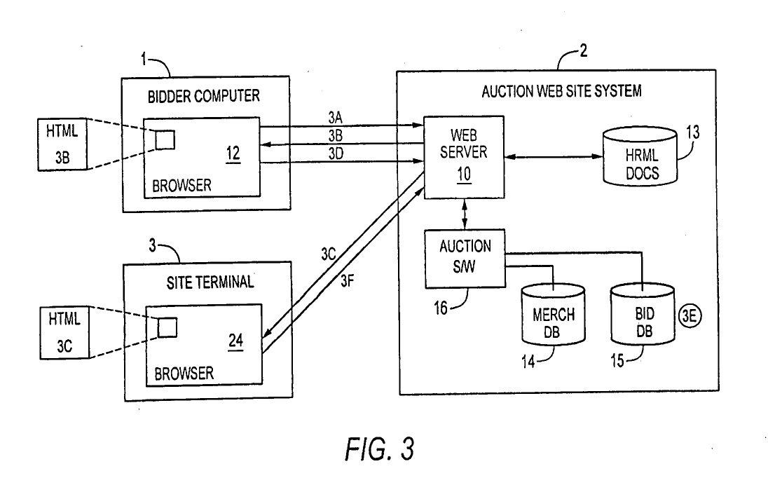

FIG. 3 demonstrates the transaction flow in an auction of a lot (23) by the system of the present invention. An online bidder who wishes to access the auction send a request (3A) from their browser (12) to the Web site (2) to receive status information or a bid entry form from the server (10). The server (10) serves or sends back the requested information from its HTML document repository (13), which is shown at Step 3B. Shown at 3C, the server (10) will communicate up-to-date status information to the browser (24) of the site terminal (3).

In the case where the next action in the auction is the placement of an online bid by an online bidder, the online bidder could enter the particulars of their online bid in the HTML form and send their bid, as an HTTP post, back to the server (10). This is shown at Step 3D. The server (10), upon receipt of the online bid details 3D, will by the auction software (16) record the details of an online bid in the bid database (15). This is shown at Step 3E. Steps 3B and 3C might then be repeated, namely to refresh the auction status and bid level with respect to the auction lot to the bidders accessing the bidding session. If a live bidder next wished to place a bid, they would make their bid at the auction site (4) and an operator of the site terminal (3) would send the details of the live bid to the server (10). This is shown at Step 3F. Again, Step 3E would be repeated, namely to record the details of this bid to the bid database (15). The acceptance of online bids in this fashion would continue until the auction-closing condition was detected.

The auction software components contained in the server (10) would also be responsible for closing the auction upon detection of the auction-closing condition. As outlined in more detail above, an auction might be closed by manual triggering of the close of the auction from either the location of the site terminal (3) or the server (10), or in the alternative to a manual trigger, the auction closing condition might be a preprogrammed condition related to time passing between bids or some other calculation, and it will be understood that any such preprogrammed detection condition is also contemplated within the scope of the present invention.

Media Capture

It is specifically contemplated that the system and method of the present invention might lend themselves to use in a hybrid auction format combining online bidding with the format of a traditional auction including an auctioneer at an auction site (4). The experience of being in attendance at the auction site (4) can be communicated to online bidders (7) at their bidder computers (1) by capturing various media input such as audio or video footage at the auction venue (4) and transmitting that to the browsers (12) of the bidder computers (1).

It is specifically contemplated that at least one media capture device, such as a microphone or video camera, could be used at the site venue (4) and could be operatively connected to the site terminal (3). Software components in the site terminal (3) could include the necessary s software to transmit the input from the one or more media capture devices at the auction venue (4) from the site terminal (3) to the server (10) of the Web site system (2), and additional software components within the Web site server (10) could then redistribute or broadcast that content to the bidder computers (1) which could be modified with the necessary software components or plug-ins in the browser (12) to receive this information

It is specifically contemplated that the media capture device(s) used at the location (4) might include audio microphones or video cameras or the like, to provide audio and video coverage of the actual auction taking place at the venue (4) to online bidders (7) at their bidder computers (1).

By simply capturing the audio or video content at the auction location (4) and transmitting it from the site terminal (3) to the server (10) for distribution to the bidder computers (1), the processor intensive task of streaming or serving that content to the bidder computers (1) is consolidated at the server (10) rather than requiring additional processing overhead at the site terminal (3). This is in keeping with the intention of the present invention to keep the equipment requirements at the auction site (4) at a minimum.

The site terminal (3) might be adapted to process the input from the media capture devices, ie. microphones or cameras, in advance of transmission of same to the server (10). For example, the site terminal (3) might have software components installed therein which would compress the signals or input from the media capture devices before transmitting same to the server (10) of the Web site system (2), which would decrease the bandwidth requirements of the connection between the site terminal (3) and the server (10).

In the case of audio or video data being captured at the auction location (4) for eventual transmission to the bidder computers (1), the server (10) might be adapted with the necessary hardware and/or software components to use streaming technology or some other method of broadcasting of such content to bidder computers (1), and then the browser (12) in the bidder computer (1) must simply have the proper plug-in or software components added thereto in order to view or receive this information. For example, in the case where a bidder computer (1) was a Microsoft Windows™ (computer operating the Internet Explorer™ web browser, by installation of an audio or video plug-in, an online bidder (7) would be able to hear the auctioneer at the auction location at their bidder computer (1).

It will be understood that the provision of both audio and video by use of more than one media capture device would provide the best simulated hybrid auction experience for online bidders (7), but it will also be understood that either video, audio or some other media capture device could be used and that the provision of only one media stream is also contemplated within the scope of the present invention, in certain circumstances, one media s capture device might be able to capture both audio and video and that might be able to be broadcast to bidder computers (1) via the site terminal (3) and the server (10), as a single media stream. It will again be understood that all such variations are contemplated within the scope hereof.

Communication Between the Site Terminal and the Server

As outlined in detail herein, one of the primary objectives of the present invention is to allow for the operation of a hybrid auction sale wherein a traditional live auction could be held, and online bidders could participate as well as live bidders at the auction site. In order to maximize the attraction of this type of an auction method, it is necessary to minimize the site requirements at the auction site (4) by requiring as little hardware as possible to be installed therein. It is specifically contemplated that the site terminal (3) could be connected to the remainder of the Web site system (2) and its server (10) either by way of a wired connection or a modem connection, or alternative as a wireless connection. The protocol used to communicate between a site terminal (3) and the Web site system (2) might be TCPIP or another Internet protocol, or some type of an internal or proprietary networking protocol might alternatively be used, and it will be understood that the concept of the present invention applies equally to any type of a communications link between the Web site system (2) and the site terminal (3) regardless of the hardware or communications protocols employed.

Conclusion

While the invention has been described herein with reference to certain preferred embodiments, these embodiments have been presented by way of example only, and not to limit the scope of the invention. Accordingly, the scope of the invention should be defined only in accordance with the claims that follow. In the following claims, reference characters used to designate claim steps are provided for convenience of description only, and are not intended to imply any particular order for performing the steps.

1. An apparatus for the conduct of an auction from a physical location allowing for the participation of both live bidders and online bidders, said apparatus comprising:
a) an auction web site system including auction software components;
b) at least one bidder computer, each bidder computer configured to record online bids from an online bidder and able to communicate the details of the online bid with the auction web site system; and
c) at least one site terminal operatively connected to said auction web site system, each site terminal configured to record live bids from multiple live bidders and able to communicate the details of said live bids with said auction web site system auction software components;
wherein said site terminal is configured to record live bids from a plurality of live bidders by recording at the time a live bid is made by a live bidder, the amount of the live bid and a live bidder identifier, to identify which of said multiple live bidders made said live bid in a bid database and entered by an independent operator at said site terminal;
wherein online bids and live bids are recorded by said auction software components in said bid database in said web site system.

2. The apparatus of claim 1 wherein up-to-date status information of the auction is displayed to bidders by the Web site system.

3. The apparatus of claim 1 wherein live bids and online bids are recorded by the web site system in the order received.

4. The apparatus of claim 1 further comprising at least one media capture device operatively connected to said site terminal, wherein the media input from said media capture device is transmitted by said site terminal to said Web site system, where said Web site system includes media broadcast components which will transmit said media input from said media capture device to bidder computers.

5. The apparatus of claim 4 wherein said site terminal processes said media input before transmitting same to said web site system.

6. The apparatus of claim 5 wherein said media input is compressed before transmission of same to said Web site system.

7. The apparatus of claim 2 wherein said web site system provides up to date auction status information to an online bidder by transmitting said information to the bidder computer of said online bidder.

8. The apparatus of claim 2, wherein said web site system provides up to date auction status information to live bidders by transmitting said information to the site terminal.

9. The apparatus of claim 1 wherein each live bid or online bid is time-stamped when received by said web site system.

10. The apparatus of claim 9 wherein bids are accepted chronologically in order of their time-stamps.

11. The apparatus of claim 1 wherein the web site system and the site terminal are one computer.

12. The apparatus of claim 1 wherein the web site system and the site terminal are separate computers.

13. The apparatus of claim 1 wherein the web site system is not located at the auction location.

14. The apparatus of claim 1 wherein said auction software components comprise:
a) a merchandise database containing information pertaining to auction lots;
b) said bid database containing details of bids received from bidders with respect to auction lots;
c) an auction control system which during the conduct of an auction will receive live bid details from the site terminal and online bids from bidder computers and record the details of said bids in the bid database; and which upon detection of an auction—closing condition will accept no further bids and the successful bidder will be determined based on accepted bids stored in the bid database.

15. The apparatus of claim 14 wherein the auction-closing condition is a manually initialed closing of an auction by an operator of said Web site system.

16. The apparatus of claim 14 wherein the auction-closing condition which is detected is a based on a preprogrammed formula which can be automatically detected by the auction control system.

17. The apparatus of claim 16 wherein the auction-closing condition which is detected is the passage of a predetermined amount of time between the placement of bids.

18. A method of conducting an auction at an auction location allowing the placement of online bids from online bidders as well as the placement of live bids from live bidders present at the auction location, said method comprising:
a) providing an auction web site system which can communicate with the bidder computers of online bidders, said web site system including auction software components capable of receiving and recording online bids and live bids in respect of auction lots;
b) providing a site terminal at the auction location operatively connected to said web site system;
c) with respect to an auction lot, using said web site system and site terminal to conduct an auction in the following steps:
i) accepting online bidders to transmit online bids from bidder computers to said web site system;
ii) allowing a plurality of live bidders to place live bids at said site terminal of the auction location, said live bids being associated with a unique bidder number and transmitted from said site terminal to said web site system, said live bids entered into said web site system at said site terminal at said auction location by an independent second entity;
iii) recording each of said online bids and each of said plurality of live bids entered on said site terminal at said auction location received by the Web site system individually in a database;
iv) upon detection of an auction—closing condition, ceasing the acceptance of any further bids by said web site system.

19. The method of claim 18 further comprising determining the successful bidder after detection of the auction-closing condition.

20. The method of claim 18 wherein the conduct of the auction further comprises displaying information pertaining to the auction lot to online bidders at their bidder computers.

21. The method of claim 18 wherein bids are recorded in said web site system in the order which they are received.

22. The method of claim 18 further comprising providing at least one media capture device operatively connected to said site terminal, and transmitting media input from said media capture device from the site terminal to the Web site system, and then broadcasting said media input from said Web site system to bidder computers.

23. The method of claim 22 further comprising processing of the media input from said media capture device by the site terminal in advance of transmitting same to said Web site system.

24. The method of claim 23 wherein the processing of the media input from the site terminal includes compressing said media input.

25. The method of claim 18 wherein the conduct of the auction further comprises the step of displaying up to date auction status information to all bidders.

26. The method of claim 18 wherein each live bid or online bid is time-stamped when received by said Web site system.

27. The method of claim 26 wherein bids are accepted and processed by the Web site system chronologically in order of their time stamps.

28. A method of coordinating a live auction at a defined live auction location with placement of online bids from online bidders for a plurality of auction lots, said method comprising:
a) providing an auction web site system which can communicate with a plurality of online bidding computers, said web site system including auction software components capable of receiving and recording online bids from said plurality of online bidder computers in respect of said auction lots;
b) providing a site terminal at said defined live auction location, said site terminal operatively connected to said web site system and able to integrate a plurality of live auction bids into said auction web site system from said single site terminal;
c) said web site system and site terminal conducting an auction in the following steps:
(i) accepting bids from said plurality of online bidder computers;
(ii) allowing live bidders to place live bids at said live auction location, said live bids being transmitted from said site terminal to said web site system, said live bids entered into said web site system at said site terminal at said auction location by an independent second entity;
(iii) recording said online bids and said plurality of live auction bids received by said web site system in a database;
(iv) differentiating said plurality of live auction bids; and
(v) upon detection of an auction—closing condition, ceasing the acceptance of any further bids by said web site system.
